(19) United States
(12) Patent Application Publication
(10) Pub. No.: US 2026/0252642 A1
(43) Pub. Date: Aug. 27, 2026

(54) METHOD FOR SEARCHING ACCESSIBLE RESOURCES ON A DATA NETWORK

(71) Applicant: QWANT, PARIS (FR)

(72) Inventor: Eric LEANDRI, Paris (FR)

(21) Appl. No.: 16/467,313

(22) PCT Filed: Dec. 8, 2017
(86) PCT No.: PCT/FR2017/053480

§ 371 Date: Feb. 3, 2020

(30) Foreign Application Priority Data
Dec. 8, 2016 (FR) 1662150
Dec. 8, 2016 (FR) 1662156
Dec. 8, 2016 (FR) 1662168

(51) Int. Cl. G06F 16/9535; G06F 16/2457; G06F 16/9538; G06F 21/35

(52) U.S. Cl. CPC G06F 16/9535; G06F 16/24578; G06F 16/9538; G06F 21/35

(57) ABSTRACT

The method (100) for searching accessible resources on a data network comprises:—a step (105) of unlocking on a computer terminal, by the user, the access to a local user profile of the user,—a step (110) of entering search keywords by the user on the terminal in order to form a search request on the network,—a step (115) of local enrichment of the search request as a function of the user profile,—a step (120) of transmitting the enriched request to a computer server,—a step (125) of receiving results of the enriched search, transmitted by the server, and—a step (130) of displaying the results on a screen of the terminal.

### TECHNICAL FIELD OF THE INVENTION

The present invention relates to a method for searching accessible resources on a data network. It applies, in particular, to optimizing the relevance of search results from a user's request to search resources on an internet type of network.

### STATE OF THE ART

In the field of searching computer resources on the internet, online search engines, accessible via an internet browser, are now utilized.

These search engines base the results provided, in response to a request, on an indexation of the content and a profiling of the user by the online search engine.

The drawback of the current search engines is that they intrude into users' private lives, especially through the profiling action which boils down to monitoring the users' actions and the association of behaviors or the detection of associated interests to provide more relevant information with each search.

For this reason, these search engines are limited to searches of computer resources on the internet.

Other internal, private search modules, built into the operating systems, make it possible to access the computer content of the terminal associated to the operating system.

Therefore, there is currently no search system making it possible to aggregate public internet search results and private search results without entry into the user's private life to determine the relevance of the results.

### SUBJECT OF THE INVENTION

The present invention aims to remedy all or part of these drawbacks.

According to a first aspect, the present invention envisages a method for searching accessible resources on a data network, which comprises:
a step of the user on a computer terminal unlocking access to a local user profile of the user;
a step of the user entering search keywords on the terminal in order to form a search request on the network;
a step of locally enriching the search request as a function of the user profile;
a step of transmitting the enriched request to a computer server;
a step of receiving results of the enriched search transmitted by the server; and
a step of displaying the results on a screen of the terminal.

Thanks to these provisions, the profile and access to it remain in the user's possession. Therefore, if the user wants to be profiled for the search, the user unlocks access to the profile. If the user does not want to be profiled for the search, the user does not unlock access to the profile. When the user unlocks access to the profile, the request is enriched in the same way as when it is enriched by a search engine using online profiling of the user. In this way, the relevance of the search results is maintained but without impinging on the user's private life.

This is because, thanks to these provisions, the online search engine has no need to know who is performing the search in order to provide relevant results since the request is already relevant.

In some embodiments, the method that is the subject of the present invention comprises:
a step of detecting how events performed by the user on this terminal are handled; and
a step of editing the user profile as a function of at least one treatment detected.

These embodiments make it possible to increase the relevance of the user profile as a function of local acts of this user, which has the effect of improving the quality of the requests issued and therefore of the search performed by the user.

In some embodiments, the user profile is edited during the editing step, as a function of at least one treatment of the displayed information performed by the user on the terminal.

These embodiments make it possible to optimize the profile as a function of the treatment performed on the search results produced by the method.

In some embodiments, the method that is the subject of the present invention comprises a step of associating remote personal information storage services, the user profile being edited during the editing step, as a function of at least one treatment performed on one item of information of each associated service.

These embodiments enable the profiling of the user to be performed based on services the user has subscribed to, as though they fell within the scope of the profiling of the user on the terminal.

In some embodiments, the method that is the subject of the present invention comprises a step of locally ranking search results received by the terminal as a function of the local user profile.

These embodiments enable the information presentation to be refined locally in order to present the most relevant results for the user first of all.

In some embodiments, the unlocking step is performed remotely from the terminal.

These embodiments enable the unlocking procedure to be centralized so as to limit a malicious third party's ability to exploit a security vulnerability of the terminal.

In some embodiments, the unlocking step comprises a step of authenticating the portable terminal on a cellular telephone network.

For the unlocking, these embodiments utilize a different network from the computer network used for the search performed.

In some embodiments, the unlocking step utilizes a virtual SIM card.

According to a second aspect, the present invention envisages a method for searching accessible resources on a data network, which comprises:
a step of the user on a computer terminal unlocking access to a local user profile of the user;
a step of the user entering search keywords on the terminal in order to form a search request;
a step of transmitting the request to a computer server;
a step of the server generating a set of search requests supplemented by adding keywords to the transmitted search request as a function of the keywords of the transmitted request;
a step of the terminal receiving enriched search results, for each search request, transmitted by the server;
a step of weighting each received result based on the user profile; and
a step of displaying the weighted results on a screen of the terminal.

Thanks to these provisions, the profile and access to it remain in the user's possession. Therefore, if the user wants the search results to be varied as a function of his profile, the user unlocks access to the profile. If the user does not want these results to be filtered as a function of his profile, the user does not unlock access to the profile. When the user unlocks access to the profile, the search results based on the additional requests are filtered so as to produce a similar result to the results provided by a search engine using online profiling of the user to provide search results. In this way, the relevance of the search results is maintained but without impinging on the user's private life.

This is because, thanks to these provisions, the online search engine has no need to know who is performing the search in order to provide relevant results since the results are filtered at the terminal and therefore closer to the user.

In some embodiments, the method that is the subject of the present invention comprises:
a step of detecting how events performed by the user on this terminal are handled; and
a step of editing the user profile as a function of at least one treatment detected.

These embodiments make it possible to increase the relevance of the user profile as a function of local acts of this user, which has the effect of improving the quality of the requests issued and therefore of the search performed by the user.

In some embodiments, the user profile is edited during the editing step, as a function of at least one treatment of one item of displayed information performed by the user on the terminal.

These embodiments make it possible to optimize the profile as a function of the treatment performed on the search results produced by the method.

In some embodiments, the method that is the subject of the present invention comprises a step of associating remote personal information storage services, the user profile being edited during the editing step, as a function of at least one treatment performed of one item of information of each associated service.

These embodiments enable the profiling of the user to be performed based on services the user has subscribed to, as though they fell within the scope of the profiling of the user on the terminal.

In some embodiments, the method that is the subject of the present invention comprises a step on the server of determining keywords additional to the keywords entered, which step utilizes a local semantic dictionary, the keywords determined being used during the generation step.

These embodiments make it possible to improve the relevance of the search results.

In some embodiments, the unlocking step is performed remotely from the terminal.

These embodiments enable the unlocking procedure to be centralized so as to limit a malicious third party's ability to exploit a security vulnerability of the terminal.

In some embodiments, the unlocking step comprises a step of authenticating the portable terminal on a cellular telephone network.

For the unlocking, these embodiments utilize a different network from the computer network used for the search performed.

In some embodiments, the unlocking step utilizes a virtual SIM card.

According to a third aspect, the present invention envisages a method for searching accessible resources on a data network, which comprises:
a step of the user on a computer terminal unlocking access to a local user profile of the user;
a step of the user entering search keywords on the terminal;
a step of locally creating a primary search request as a function of entered keywords;
a step of enriching the request by adding keywords to form a plurality of secondary requests;
a step of transmitting each secondary request to a computer server;
a step of receiving search results transmitted by the server for each request;
a step of weighting each received result based on the user profile; and
a step of displaying the weighted results on a screen of the terminal.

Thanks to these provisions, the profile and access to it remain in the user's possession. Therefore, if the user wants to be profiled for the search, the user unlocks access to the profile. If the user does not want to be profiled for the search, the user does not unlock access to the profile. When the user unlocks access to the profile, a multitude of secondary requests, based on the user profile and on the primary request entered, is transmitted to the search engine. As a consequence, during reception the relevance of the search results is maintained but without impinging on the user's private life.

This is because, thanks to these provisions, the online search engine has no need to know who is performing the search in order to provide relevant results since the relevance of the results is handled at the terminal.

In some embodiments, the method that is the subject of the present invention comprises a step of determining keywords additional to the keywords entered, which step utilizes a local semantic dictionary, the keywords determined being used during the enrichment step.

These embodiments make it possible to improve the relevance of the search results.

In some embodiments, the enrichment step is performed by adding keywords determined as a function of the user profile.

In some embodiments, the method that is the subject of the present invention comprises:
a step of detecting how events performed by the user on this terminal are handled; and
a step of editing the user profile as a function of at least one treatment detected.

These embodiments make it possible to increase the relevance of the user profile as a function of local acts of this user, which has the effect of improving the quality of the requests issued and therefore of the search performed by the user.

In some embodiments, the user profile is edited during the editing step, as a function of at least one treatment of one item of displayed information performed by the user on the terminal.

These embodiments make it possible to optimize the profile as a function of the treatment performed on the search results produced by the method.

In some embodiments, the method that is the subject of the present invention comprises a step of associating remote personal information storage services, the user profile being edited during the editing step, as a function of at least one treatment performed of one item of information of each associated service.

These embodiments enable the profiling of the user to be performed based on services the user has subscribed to, as though they fell within the scope of the profiling of the user on the terminal.

In some embodiments, the unlocking step is performed remotely from the terminal.

These embodiments enable the unlocking procedure to be centralized so as to limit a malicious third party's ability to exploit a security vulnerability of the terminal.

In some embodiments, the unlocking step comprises a step of authenticating the portable terminal on a cellular telephone network.

For the unlocking, these embodiments utilize a different network from the computer network used for the search performed.

In some embodiments, the unlocking step utilizes a virtual SIM card.

All of these aspects can be combined in an advantageous way.

### BRIEF DESCRIPTION OF THE FIGURES

Other advantages, aims and particular features of the invention will become apparent from the non-limiting description that follows of at least one particular embodiment of the method that is the subject of the present invention, with reference to drawings included in an appendix, wherein:

FIG. 1 represents, schematically and in the form of a logical diagram, a particular series of steps of a first embodiment of the method that is the subject of the present invention;

FIG. 2 represents, schematically and in the form of a logical diagram, a particular series of steps of a second embodiment of the method that is the subject of the present invention; and

FIG. 3 represents, schematically and in the form of a logical diagram, a particular series of steps of a third embodiment of the method that is the subject of the present invention.

### DESCRIPTION OF EXAMPLES OF REALIZATION OF THE INVENTION

The present description is given in a non-limiting way, each characteristic of an embodiment being able to be combined with any other characteristic of any other embodiment in an advantageous way.

It is now noted that the figures are not to scale.

The term “information” refers to digital data that can take the form of text, image, sound, video or executable files or internet pages. This term is synonymous with “computer resources”. This term also means any address of digital data such as the data mentioned above.

The term “internet” refers to the World Wide Web internet network.

The term “internet browser” refers to software designed for browsing and displaying the World Wide Web having at least one area for entering search keywords and an interface for displaying search results.

The term “terminal” refers to an electronic device comprising a man-machine interface, a means for communicating with the internet network, and a display screen, this terminal being configured to run the internet browser. As an illustration, a terminal can be:
a smartphone;
a digital tablet; or
a personal computer.

The term “event” refers to any interaction, via a human interface, of the user with the terminal that has an effect on at least one execution parameter of a software system of the terminal. Such an interaction can be:
entering search keywords, in an internet browser for example;
viewing a file;
running a file.

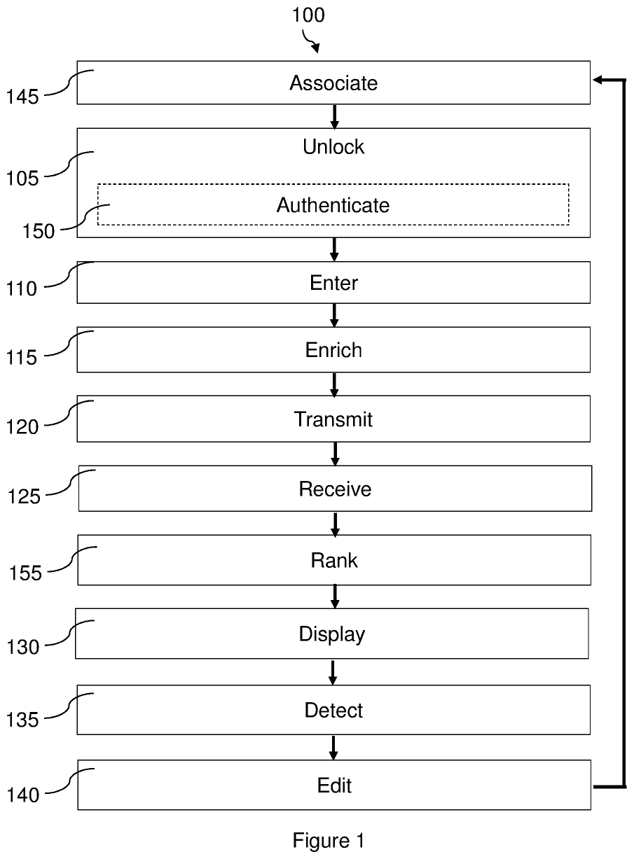

FIG. 1 shows a schematic view of a logical diagram of particular steps for realizing the method 100 that is the subject of the present invention. This method 100 for searching accessible resources on a data network comprises:
a step 105 of the user on a computer terminal unlocking access to a local user profile of the user;
a step 110 of the user entering search keywords on the terminal in order to form a search request on the network;
a step 115 of locally enriching the search request as a function of the user profile;
a step 120 of transmitting the enriched request to a computer server;
a step 125 of receiving results of the enriched search transmitted by the server; and
a step 130 of displaying the results on a screen of the terminal.

This unlocking step 105 utilizes any type of mechanism for unlocking access to known computer content. Such a mechanism is, for example, the comparison of a code entered by the user, via the man-machine interface of the terminal, with a code previously saved on the terminal or remote from this terminal. In other variants, the mechanism is a biometric identification mechanism using fingerprint or ocular recognition.

In particular, this unlocking step 105 can be performed by a plug-in module of a browser installed by the user or pre-installed on the browser.

In some variants, the unlocking step 105 is utilized remotely with reference to the terminal.

In some particular embodiments, such as that shown in FIG. 1, the unlocking step 105 comprises a step 150 of authenticating the portable terminal on a cellular telephone network.

This authentication step 150 is performed, for example, by authenticating a SIM card associated with the terminal on a cellular telephone network.

In some variants, the unlocking step 105 utilizes a virtual SIM card.

A virtual SIM card is a rewritable dedicated memory space in the terminal, whose content is transmitted by a radio channel, this content comprising the identification data of the terminal on a cellular telephone network.

The entry step 110 is performed by any type of man-machine interface known to the person skilled in the art. Such an interface is, for example, a mechanical keyboard, virtual keyboard, touch keyboard, mouse or voice command interface.

The man-machine interface employed depends on the terminal running the internet browser.

By means of this man-machine interface, the user fills in entered keywords in a search field of the internet browser. These keywords correspond to the search objects desired by the user.

The entered keywords are grouped together to form a search request. For example, these keywords can be “Restaurant”, “This evening”.

In current systems, when the user confirms the entered keywords, the search request is sent to a server hosting a search engine configured to associate information to keywords.

In this first embodiment, prior to sending the search request, this request is enriched 115.

This enrichment is produced, for example, by adding keywords to the request, these keywords being determined as a function of the user profile.

For example, if the terminal is geolocated to Rome, Italy, the following request is enriched by adding the keyword “Rome” so as to limit the results to those which present a greater likelihood of corresponding to the user's requirements.

This enrichment is performed at the terminal so as to preserve the user's anonymity on the search engine side. The search engine knows the keywords of the request, but not the treatments and information on which these keywords were based.

The transmission step 120 is performed, for example, by utilizing an electronic control circuit of a communication interface of the terminal. This communication interface is, for example, an antenna or a port for connecting a computer link cable.

The communication interface is, for example, an antenna configured to utilize the IEEE 802.11 standard, known as “Wi-Fi”, or a cellular data network.

During this transmission step 120, the search request is transmitted to the server.

The reception step 125 is performed in a similar way to the transmission step 120.

During this step, at least one search result, in the form of a link to a computer resource on the data network, is received by the terminal.

The display step 130 is performed, for example, by utilizing an electronic control circuit of a screen of the terminal to display the search results received during the reception step 125 in an internet browser.

In some embodiments, the method that is the subject of the present invention comprises:
a step 135 of detecting how events performed by the user on this terminal are handled; and
a step 140 of editing the user profile as a function of at least one treatment detected.

The step 135 of detecting the treatment of events is performed, for example, by utilizing an electronic control circuit associated to a software system configured to detect actions performed by a user on the terminal. These actions, associated to an event, can be dated.

The editing step 140 is performed, for example, by an electronic calculation circuit associated to a software system, this software system being configured to determine a user profile as a function of treatments performed on events. This profile relates, for example, to the user's preferences, statically or over time, to the correlation between a series of events, such as successive searches, or to a frequency of occurrence of identified events.

In some embodiments, the user profile is edited during the editing step 140, as a function of at least one treatment of the displayed information performed by the user on the terminal.

This makes it possible to take the user's preferences, as regards the subject of the searches performed, into account in the profile so as to extract probable intentions from them, these probable intentions enabling the search results to be better selected in the future.

In some embodiments, the method 100 that is the subject of the present invention comprises a step 145 of associating remote personal information storage services, the user profile being edited during the editing step 140, as a function of at least one treatment performed on one item of information of each associated service.

This association step 145 is performed, for example, by the user entering on the terminal:
an identity of the service to be associated; and
identifiers enabling the connection to this service on behalf of the user.

This association step 145 utilizes the establishment of a computer communication between the terminal and each service associated in this way by means of identifiers entered and recorded.

Such an association can be deleted by the user.

In some embodiments, the method 100 that is the subject of the present invention comprises a step 145 of locally ranking search results received by the terminal as a function of the local user profile.

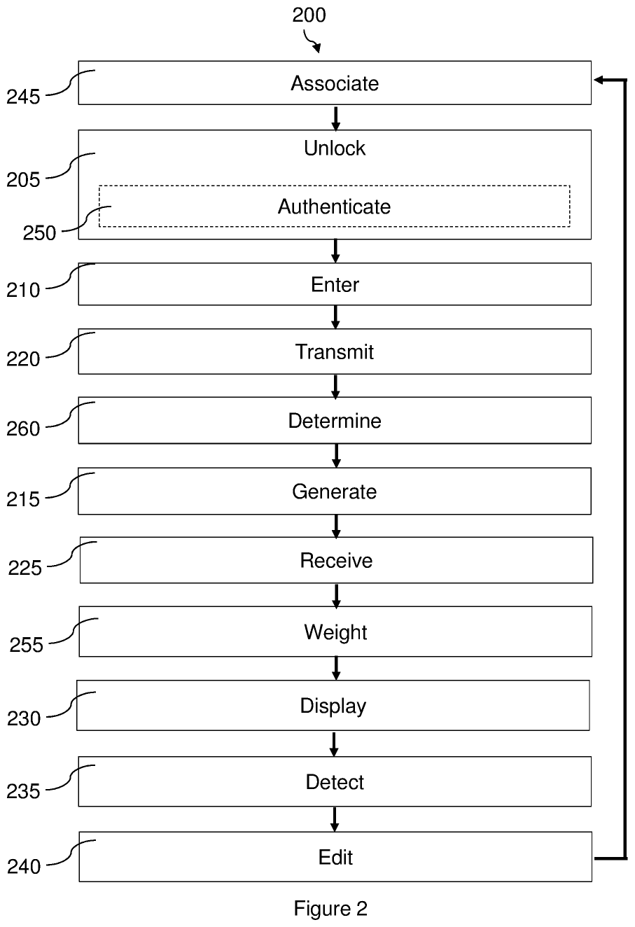

FIG. 2 shows, schematically, an embodiment of the method 200 that is the subject of the present invention. This method 200 for searching accessible resources on a data network comprises:
a step 205 of the user on a computer terminal unlocking access to a local user profile of the user;
a step 210 of the user entering search keywords on the terminal in order to form a search request;
a step 220 of transmitting the request to a computer server;
a step 215 of the server generating a set of search requests supplemented by adding keywords to the transmitted search request as a function of the keywords of the transmitted request;
a step 225 of the terminal receiving enriched search results, for each search request, transmitted by the server;
a step 255 of weighting each received result based on the user profile; and
a step 235 of displaying the weighted results on a screen of the terminal.

This unlocking step 205 utilizes any type of mechanism for unlocking access to known computer content. Such a mechanism is, for example, the comparison of a code entered by the user, via the man-machine interface of the terminal, with a code previously saved on the terminal or remote from this terminal. In other variants, the mechanism is a biometric identification mechanism using fingerprint or ocular recognition.

In particular, this unlocking step 205 can be performed by a plug-in module of a browser installed by the user or pre-installed on the browser.

In some variants, the unlocking step 205 is utilized remotely with reference to the terminal.

In some particular embodiments, such as that shown in FIG. 2, the unlocking step 205 comprises a step 250 of authenticating the portable terminal on a cellular telephone network.

This authentication step 250 is performed, for example, by authenticating a SIM card associated with the terminal on a cellular telephone network.

In some variants, the unlocking step 205 utilizes a virtual SIM card.

A virtual SIM card is a rewritable dedicated memory space in the terminal, whose content is transmitted by a radio channel, this content comprising the identification data of the terminal on a cellular telephone network.

The entry step 210 is performed by any type of man-machine interface known to the person skilled in the art. Such an interface is, for example, a mechanical keyboard, virtual keyboard, touch keyboard, mouse or voice command interface.

The man-machine interface employed depends on the terminal running the internet browser.

By means of this man-machine interface, the user fills in entered keywords in a search field of the internet browser. These keywords correspond to the search objects desired by the user.

The entered keywords are grouped together to form a search request. For example, these keywords can be “Restaurant”, “This evening”.

The transmission step 220 is performed, for example, by utilizing an electronic control circuit of a communication interface of the terminal. This communication interface is, for example, an antenna or a port for connecting a computer link cable.

The communication interface is, for example, an antenna configured to utilize the IEEE 802.11 standard, known as “Wi-Fi”, or a cellular data network.

During this transmission step 220, the search request is transmitted to the server.

In current systems, when the user confirms the entered keywords, the search request is sent to a server hosting a search engine configured to associate information to keywords.

The information returned in response to the request are therefore dependent on the user's profile maintained by the search engine.

In this second embodiment, no profile is maintained by the search engine.

Instead, the method comprises a mechanism formed of the generation 215 and weighting 255 steps.

During the generation step 215, the search engine generates a set of additional requests from the primary request transmitted by the terminal.

These secondary requests are formed by adding keywords close to the keywords entered. The closeness between keywords can be observed statistically as a function of the monitoring of events performed on the information displayed by all the users of the search engine, keywords being attached to each item of information. Therefore, for example, if the users of the search engine click on information relating to the author Victor Hugo and other information relating to a street called Victor Hugo, the search engine identifies two complementary requests, when a user enters “Victor Hugo”, these two complementary requests being “Rue Victor Hugo” and “Author Victor Hugo”.

All the results of these two searches are returned to the terminal.

In some embodiments, the method 200 that is the subject of the present invention comprises a step 260 on the server of determining keywords additional to the keywords entered, which step utilizes a local semantic dictionary, the keywords determined being used during the generation step.

The reception step 225 is performed in a similar way to the transmission step 220.

During this step 225, at least one search result, in the form of a link to a computer resource on the data network, is received by the terminal.

The weighting step 255 is performed, for example, by assigning to each item of information received a relevance score as a function of the match between the user's profile and the information received.

For example, if the user is geolocated in Rennes, the search results for “Rue Victor Hugo” are weighted to highlight the search results applying to Rennes.

This weighting is performed at the terminal so as to preserve the user's anonymity on the search engine side. The search engine knows the keywords of the request, but not the treatments and information taking part in the weighting of the results.

The display step 230 is performed, for example, by utilizing an electronic control circuit of a screen of the terminal to display the search results received during the reception step 225 in an internet browser.

In some embodiments, the method that is the subject of the present invention comprises:
a step 235 of detecting how events performed by the user on this terminal are handled; and
a step 240 of editing the user profile as a function of at least one treatment detected.

The step 235 of detecting the treatment of events is performed, for example, by utilizing an electronic control circuit associated to a software system configured to detect actions performed by a user on the terminal. These actions, associated to an event, can be dated.

The editing step 240 is performed, for example, by an electronic calculation circuit associated to a software system, this software system being configured to determine a user profile as a function of treatments performed on events. This profile relates, for example, to the user's preferences, statically or over time, to the correlation between a series of events, such as successive searches, or to a frequency of occurrence of identified events.

In some embodiments, the user profile is edited during the editing step 240, as a function of at least one treatment of the displayed information performed by the user on the terminal.

This makes it possible to take the user's preferences, as regards the subject of the searches performed, into account in the profile so as to extract probable intentions from them, these probable intentions enabling the search results to be better selected in the future.

In some embodiments, the method 200 that is the subject of the present invention comprises a step 245 of associating remote personal information storage services, the user profile being edited during the editing step 240, as a function of at least one treatment performed on one item of information of each associated service.

This association step 245 is performed, for example, by the user entering on the terminal:
an identity of the service to be associated; and
identifiers enabling the connection to this service on behalf of the user.

This association step 245 utilizes the establishment of a computer communication between the terminal and each service associated in this way by means of identifiers entered and recorded.

Such an association can be deleted by the user.

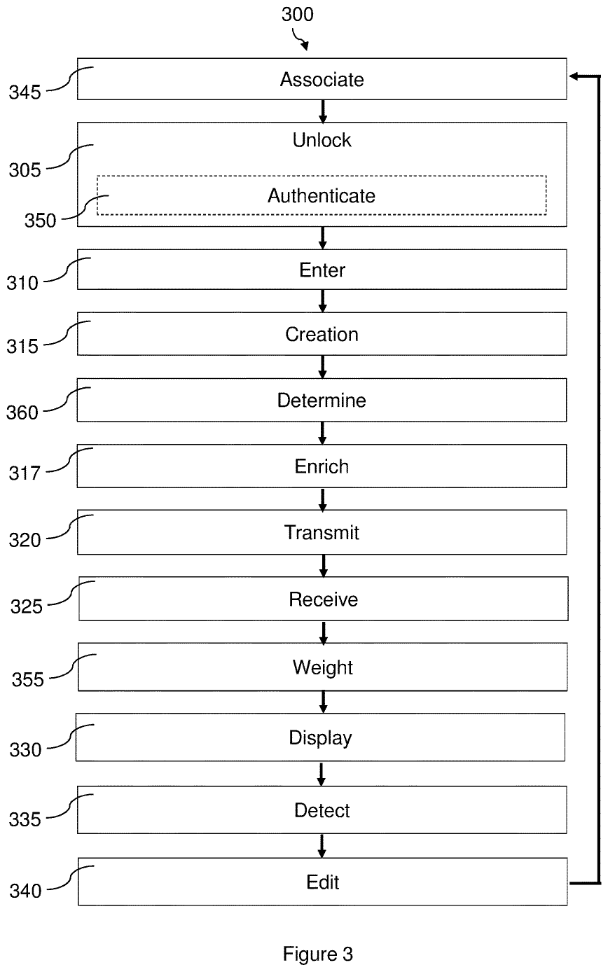

FIG. 3 shows, schematically, an embodiment of the method 300 that is the subject of the present invention. This method 300 for searching accessible resources on a data network comprises:
a step 305 of the user on a computer terminal unlocking access to a local user profile of the user;
a step 310 of the user entering search keywords on the terminal;
a step 315 of locally creating a primary search request as a function of entered keywords;
a step 317 of enriching the request by adding keywords to form a plurality of secondary requests;
a step 320 of transmitting each secondary request to a computer server;
a step 325 of receiving search results transmitted by the server for each request;
a step 355 of weighting each received result based on the user profile; and
a step 330 of displaying the weighted results on a screen of the terminal.

The unlocking step 305 utilizes any type of mechanism for unlocking access to known computer content. Such a mechanism is, for example, the comparison of a code entered by the user, via the man-machine interface of the terminal, with a code previously saved on the terminal or remote from this terminal. In other variants, the mechanism is a biometric identification mechanism using fingerprint or ocular recognition.

In particular, this unlocking step 305 can be performed by a plug-in module of a browser installed by the user or pre-installed on the browser.

In some variants, the unlocking step 305 is utilized remotely with reference to the terminal.

In some particular embodiments, such as that shown in FIG. 3, the unlocking step 305 comprises a step 350 of authenticating the portable terminal on a cellular telephone network.

This authentication step 350 is performed, for example, by authenticating a SIM card associated with the terminal on a cellular telephone network.

In some variants, the unlocking step 305 utilizes a virtual SIM card.

A virtual SIM card is a rewritable dedicated memory space in the terminal, whose content is transmitted by a radio channel, this content comprising the identification data of the terminal on a cellular telephone network.

The entry step 310 is performed by any type of man-machine interface known to the person skilled in the art. Such an interface is, for example, a mechanical keyboard, virtual keyboard, touch keyboard, mouse or voice command interface.

The man-machine interface employed depends on the terminal running the internet browser.

By means of this man-machine interface, the user fills in entered keywords in a search field of the internet browser. These keywords correspond to the search objects desired by the user.

The entered keywords are grouped together to form a search request during the step 315 of creating a primary search request.

The creation step 315 utilizes, for example, an electronic calculation circuit configured to record the keywords of the primary request in a memory of the terminal.

In current systems, when the user confirms the entered keywords, the search request is sent to a server hosting a search engine configured to associate information to keywords.

In this third embodiment, the primary request is enriched during the enrichment step 317, by adding keywords to the keywords entered to form secondary requests, each secondary request corresponding to an addition.

For example, these entered keywords can be “Restaurant”, “This evening”. In a plurality of requests, the keywords “Rome”, if the user has been geolocated to Rome, or “Italian”, if the user searched for Italian restaurants in a previous search, can be added to these keywords.

This enrichment is produced, for example, by adding keywords to the request, these keywords being determined as a function of the user profile.

The keywords to be added are selected during a step 360 of determining keywords additional to the keywords entered, which step utilizes a local semantic dictionary, the keywords determined being used during the enrichment step.

This enrichment is performed at the terminal so as to preserve the user's anonymity on the search engine side. The search engine knows the keywords of the request, but not the treatments and information on which these keywords were based.

The transmission step 320 is performed, for example, by utilizing an electronic control circuit of a communication interface of the terminal. This communication interface is, for example, an antenna or a port for connecting a computer link cable.

The communication interface is, for example, an antenna configured to utilize the IEEE 802.11 standard, known as “Wi-Fi”, or a cellular data network.

During this transmission step 320, the search request is transmitted to the server.

The reception step 325 is performed in a similar way to the transmission step 320.

During this step, at least one search result, in the form of a link to a computer resource on the data network, is received by the terminal.

The weighting step 355 is performed, for example, by assigning to each item of information received a relevance score as a function of the match between the user's profile and the information received.

This weighting is performed at the terminal so as to preserve the user's anonymity on the search engine side. The search engine knows the keywords of the request, but not the treatments and information taking part in the weighting of the results.

The display step 330 is performed, for example, by utilizing an electronic control circuit of a screen of the terminal to display the search results received during the reception step 125 in an internet browser.

In some embodiments, the method that is the subject of the present invention comprises:
a step 235 of detecting how events performed by the user on this terminal are handled; and
a step 240 of editing the user profile as a function of at least one treatment detected.

The step 235 of detecting the treatment of events is performed, for example, by utilizing an electronic control circuit associated to a software system configured to detect actions performed by a user on the terminal. These actions, associated to an event, can be dated.

The editing step 240 is performed, for example, by an electronic calculation circuit associated to a software system, this software system being configured to determine a user profile as a function of treatments performed on events. This profile relates, for example, to the user's preferences, statically or over time, to the correlation between a series of events, such as successive searches, or to a frequency of occurrence of identified events.

In some embodiments, the user profile is edited during the editing step 340, as a function of at least one treatment of the displayed information performed by the user on the terminal.

This makes it possible to take the user's preferences, as regards the subject of the searches performed, into account in the profile so as to extract probable intentions from them, these probable intentions enabling the search results to be better selected in the future.

In some embodiments, the method 300 that is the subject of the present invention comprises a step 345 of associating remote personal information storage services, the user profile being edited during the editing step 340, as a function of at least one treatment performed on one item of information of each associated service.

This association step 345 is performed, for example, by the user entering on the terminal:
an identity of the service to be associated; and
identifiers enabling the connection to this service on behalf of the user.

This association step 345 utilizes the establishment of a computer communication between the terminal and each service associated in this way by means of identifiers entered and recorded.

Such an association can be deleted by the user.

1. Method (100) for searching accessible resources on a data network, characterized in that it comprises:
a step (105) of the user on a computer terminal unlocking access to a local user profile of the user;
a step (110) of the user entering search keywords on the terminal in order to form a search request on the network;
a step (115) of locally enriching the search request as a function of the user profile;
a step (120) of transmitting the enriched request to a computer server;
a step (125) of receiving results of the enriched search transmitted by the server; and
a step (130) of displaying the results on a screen of the terminal.

2. Method according to claim 1, which comprises:
a step (135) of detecting how events performed by the user on this terminal are handled; and
a step (140) of editing the user profile as a function of at least one treatment detected.

3. Method (100) according to claim 2, wherein the user profile is edited during the editing step (140), as a function of at least one treatment of the displayed information performed by the user on the terminal.

4. Method (100) according to one of claims 2 or 3, which comprises a step (145) of associating remote personal information storage services, the user profile being edited during the editing step (140), as a function of at least one treatment performed on one item of information of each associated service.

5. Method (100) according to one of claims 1 to 4, which comprises a step (145) of locally ranking search results received by the terminal as a function of the local user profile.

6. Method (100) according to one of claims 1 to 5, wherein the unlocking step (105) is performed remotely from the terminal.

7. Method (100) according to claim 6, wherein the unlocking step (105) comprises a step (150) of authenticating the portable terminal on a cellular telephone network.

8. Method (100) according to claim 7, wherein the unlocking step (105) utilizes a virtual SIM card.
